(19) United States
(12) Patent Application Publication
(10) Pub. No.: US 2014/0087869 A1
(43) Pub. Date: Mar. 27, 2014

(54) SKILL-INFLUENCED BONUS IN A GAMING MACHINE

(71) Applicant: Michael Thorne, Sparks, NV (US)

(72) Inventor: Michael Thorne, Sparks, NV (US)

(21) Appl. No.: 13/629,409

(22) Filed: Sep. 27, 2012

(51) Int. Cl. A63F 13/00

(52) U.S. Cl. 463/31

(57) ABSTRACT

Systems and methods for synchronizing audio in a bank of gaming machines, such as video slot and video poker machines. Audio tracks of a game may be provided to a plurality of gaming machines and synchronized. An audio track provided to one of the gaming machines may be changed to a second audio track, in response to receiving an indication of a status change for the game. The second audio track may be synchronized with the audio tracks provided to the other gaming machines in the plurality.

### BACKGROUND

1. Field of the Described Embodiments

The present disclosure relates generally to gaming machines, such as video poker and slot machines. The present disclosure particularly relates to a gaming machine configured to provide a skill-based bonus round within a game.

2. Description of the Related Art

Many of today's gaming casinos and other entertainment locations feature different single and multi-player gaming machines such as slot machines and video poker machines. The gaming machines may include a number of hardware and software components to provide a wide variety of game types and game playing capabilities. Exemplary hardware components may include bill validators, coin acceptors, card readers, keypads, buttons, levers, touch screens, coin hoppers, ticket printers, player tracking units and the like. Software components may include, for example, boot and initialization routines, various game play programs and subroutines, credit and payout routines, image and audio generation programs, various component modules and a random or pseudo-random number generator, among others.

Gaming machines are highly regulated to ensure fairness. In many cases, gaming machines may be operable to dispense monetary awards of a large amount of money. Accordingly, access to gaming machines is often carefully controlled. For example, in some jurisdictions, routine maintenance requires that extra personnel (e.g., gaming control personnel) be notified in advance and be in attendance during such maintenance. Additionally, gaming machines may have hardware and software architectures that differ significantly from those of general-purpose computers (PCs), even though both gaming machines and PCs employ microprocessors to control a variety of devices. For example, gaming machines may have more stringent security requirements and fault tolerance requirements. Additionally, gaming machines generally operate in harsher environments as compared with PCs.

A wager-based gaming machine may employ one or more random number generators, to determine the outcome of a game. For example, a slot machine with three reels may generate three random numbers, each random number corresponding to a reel position. In some cases, the slot machine may employ a virtual reel that maps a random number to a position of the actual reel shown to the player. Generally, a virtual reel has many more positions than the actual reel, allowing the probability of certain symbol combinations on the actual reels to vary. For example, a three reel slot machine having ten unique symbols per reel has total of 10*10*10=1,000 possible symbol combinations. If each combination of symbols has the same probability of appearing, the probability of a particular combination would be 1:1,000 (e.g., the combination of symbols 7-7-7 would statistically appear once every thousand spins). Now, assume that each reel has an associated virtual reel with 100 positions and that each of the ‘7’ symbols has only one position on a virtual reel. In such a case, the probability of the combination of symbols 7-7-7 appearing on the actual reels would then be 1:100³=1:1,000,000. Thus, the probability of jackpots and other payouts by a modern slot machine may be controlled via a virtual reel.

Many players enjoy gaming machines that rely strictly on random chance to determine a machine's payout. However, some players may feel that a game's outcome is completely outside of his or her control, once a round of the game has been initiated. Other than initiating the round (e.g., by pressing a button, pulling a lever, etc.), the player may have little or no interaction with the game until the round concludes. Over time, such players may lose interest in the game, since they have minimal interaction with the game and have no influence over the game's outcome.

### SUMMARY

According to one embodiment, a method of providing a bonus round in a gaming machine is disclosed. The method includes providing, by a processing circuit, display data for the bonus round to an electronic display. The method also includes associating, by the processing circuit, areas of the displayed bonus round with difficulty ratings. The method further includes receiving, at the processing circuit, game input from a user interface device, the game input corresponding to one of the displayed areas of the bonus round. The method additionally includes determining, by the processing circuit, a bonus limit based in part on the game input from the user interface device, the bonus limit being determined using the difficulty rating for the displayed area corresponding to the game input. The method also includes using, by the processing circuit, the bonus limit to determine a bonus award for the bonus round.

According to another embodiment, a system for providing a bonus round in a gaming machine. The system includes a processing circuit configured to provide display data for the bonus round to an electronic display and to associate areas of the displayed bonus round with difficulty ratings. The processing circuit is also configured to receive game input from a user interface device, the game input corresponding to one of the displayed areas of the bonus round. The processing circuit is further configured to determine a bonus limit based in part on the game input from the user interface device, the bonus limit being determined using the difficulty rating for the displayed area corresponding to the game input. The processing circuit is yet further configured to use the bonus limit to determine a bonus award for the bonus round.

According to a further embodiment, a computer-readable storage medium having instructions stored therein is disclosed. The instructions are executable by a processor to cause the processor to perform operations. The operations include providing display data for the bonus round to an electronic display and associating areas of the displayed bonus round with difficulty ratings. The operations also include receiving game input from a user interface device, the game input corresponding to one of the displayed areas of the bonus round. The operations further include determining a bonus limit based in part on the game input from the user interface device, the bonus limit being determined using the difficulty rating for the displayed area corresponding to the game input. The operations yet further include using the bonus limit to determine a bonus award for the bonus round.

### BRIEF DESCRIPTION OF THE DRAWINGS

The details of one or more implementations are set forth in the accompanying drawings and the description below. Other features, aspects, and advantages of the disclosure will become apparent from the descriptions, the drawings, and the claims, in which:

FIG. 1 is an illustration of a gaming machine, according to an exemplary embodiment;

FIG. 2 is an illustration of a base game being provided to a display of a gaming machine, according to an exemplary embodiment;

FIG. 3 is an illustration of a bonus round being provided to a display of a gaming machine, according to an exemplary embodiment;

FIG. 4 is an illustration of the results of a bonus round being provided to a display of a gaming machine, according to an exemplary embodiment;

FIG. 5 is a block diagram of a processing circuit configured to provide a bonus round, according to an exemplary embodiment; and

FIG. 6 is a flow diagram of a process for providing a bonus round, according to an exemplary embodiment.

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concept.

According to various aspects of the present disclosure, a gaming machine may be configured to allow a player to play a skill-based bonus round within a wager-based game. The player may operate one or more user interface devices of the gaming machine to perform skill-based actions during the bonus round. The player's level of skill may be a function of the player's dexterity in operating the one or more user interface devices of the gaming machine during the bonus round. In various embodiments, different areas of the screen during a bonus round may have different associated difficulty scores. The gaming machine may receive game input from a user interface device and determine whether the input corresponds to one of the on-screen areas. For example, a gaming machine may include a gun peripheral that allows a player to shoot at different on-screen targets having different associated difficulties during a bonus round. Thus, a level of dexterity-based skill may be introduced into a bonus round of a wager-based game available on a gaming machine.

In various embodiments, a bonus award for a bonus round may be influenced, but not completely determined, by a player's skill-based actions. In some embodiments, difficulty scores for on-screen areas hit by the player during the bonus round may be used to determine a bonus limit. However, the bonus limit may only represent a limit to the player's potential bonus award. The player's actual bonus award may be determined by randomly selecting a value from a range defined by the bonus limit and a minimum bonus award. Since the bonus limit only defines a potential bonus award, it still remains possible that an unskilled player may receive a higher bonus award than a skilled player. In one embodiment, the minimum bonus award for a player may be nonzero, regardless of his or her skill in the bonus round (e.g., the player may be guaranteed to receive at least a token bonus award, by virtue of qualifying for the bonus round).

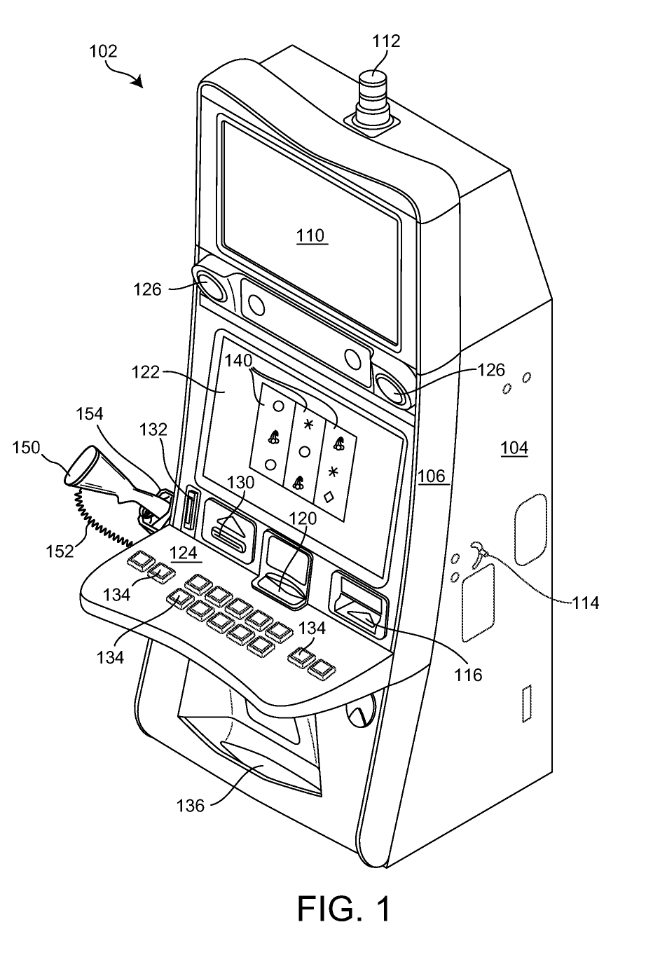

Referring to FIG. 1, a perspective drawing of an electronic gaming machine 102 is shown in accordance with described embodiments. Gaming machine 102 may include a main cabinet 104. Main cabinet 104 may provide a secure enclosure that prevents tampering with device components, such as a game controller (not shown) located within the interior of main cabinet 104. Main cabinet 104 may include an access mechanism, such as a door 106, which allows the interior of gaming machine 102 to be accessed. Actuation of a door 106 may be controlled by a locking mechanism 114. In some embodiments, locking mechanism 114, door 106, and the interior of main cabinet 104 may be monitored with security sensors of various types to detect whether the interior has been accessed. For instance, a light sensor may be provided within main cabinet 104 to detect a change in light-levels when door 106 is opened and/or an accelerometer may be attached to door 106 to detect when door 106 is opened.

Gaming machine 102 may also include devices for conducting a wager-based game. For example, gaming machine 102 may include an acceptor 116 and a printer 120. In various embodiments, gaming machine 102 may be configured to run on credits that may be redeemed for money and/or other forms of prizes. Acceptor 116 may read an inserted ticket having one or more credits usable to play a game on gaming machine 102. For example, a player of gaming machine 102 may wager one or more credits within a video slot game. If the player loses, the wagered amount may be deducted from the player's remaining balance on gaming machine 102. However, if the player wins, the player's balance may be increased by the amount won. Any remaining credit balance on gaming machine 102 may be converted into a ticket via printer 120. For example, a player of gaming machine 102 may cash out of the machine by selecting to print a ticket via printer 120. The ticket may then be used to play other gaming machines or redeemed for cash and/or prizes. According to various embodiments, gaming machine 102 may record data regarding its receipt and/or disbursement of credits. For example, gaming machine 102 may generate accounting data whenever a result of a wager-based game is determined. In some embodiments, gaming machine 102 may provide accounting data to a remote data collection device, allowing the remote monitoring of gaming machine 102.

In some cases, gaming machine 102 may be configured to receive and/or dispense physical money or tokens used by the gaming establishment. For example, gaming machine 102 may include an acceptor 132 configured to receive coins or tokens. Similarly, gaming machine 102 may include a bill acceptor. For example, acceptor 116 may be configured to accept bills in addition to, or in lieu of, tickets. Money or tokens received by gaming machine 102 may be converted into game credits. In some embodiments, gaming machine 102 may be configured to dispense money or tokens via a coin hopper 136. For example, a player may cash out of gaming machine 102 by converting any remaining game credits into money or tokens dispensed via coin hopper 136. In some cases, a threshold amount may be used by gaming machine to control whether a redeemable ticket is printed by printer 120 or a payout is paid via coin hopper 136 (e.g., small payouts below a threshold dollar amount may be paid via coin hopper 136 while larger payouts are paid via a printed ticket).

In one embodiment, gaming machine 102 may include a loyalty card acceptor 130. In general, a loyalty card may be tied to a user's loyalty account. A loyalty account may store various information about the user, such as the user's identity, the user's gaming preferences, the user's gaming habits (e.g., which games the user plays, how long the user plays, etc.), or similar information about the user. A loyalty account may also be used to reward a user for playing gaming machine 102. For example, a user having a loyalty account may be given a bonus turn on gaming machine 102 or credited loyalty points for playing gaming machine 102. Such loyalty points may be exchanged for loyalty rewards (e.g., a free meal, a free hotel stay, free room upgrade, discounts, etc.).

Gaming machine 102 may include any number of user interface devices that convey sensory information to a user and/or receive input from the user. For example, gaming machine 102 may include electronic displays 110, 122, a shooting device 150, speakers 126, and/or a candle device 112 to convey information to the user of gaming machine 102. Gaming machine 102 may also include a console 124 having one or more inputs 134 (e.g., buttons, track balls, joysticks, etc.) configured to receive input from a user. In one embodiment, display 110 and/or display 122 may also be a touch screen display configured to receive input from a user. A processing circuit may execute a game, such as a wager-based game, in response to receiving input from a user via inputs 134, display 122, or display 110. For example, inputs 134 may be operated to place a wager in the game and to run the game. In response, the controller may cause reels 140 shown on display 122 to spin, such as with a software-based slot game. In other embodiments, gaming machine 102 may include electro-mechanical reels or similar devices in addition to, or in lieu of, electronic display 122. For example, display 122 alternatively may be electro-mechanical reels configured to spin as part of a slot-based game.

In some embodiments, gaming machine 102 may run a game that includes one or more skill-based bonus rounds (e.g., portions of gameplay that require the dexterous use of an input device to achieve certain in-game goals). Gaming machine 102 may also alert a player to the presence of the skill-based bonus round. For example, gaming machine 102 may include an advisory notice on main cabinet 104 that alerts players to the presence of a skill-based bonus round available on gaming machine 102. In another example, gaming machine 102 may provide such a notice to one or both of displays 110, 122. Entry into a bonus round may be determined randomly, periodically (e.g., after n-number of rounds of the base game), based on a player's loyalty account (e.g., after the player has accumulated a certain number of loyalty points), or based on any number of other factors. During a bonus round, gaming machine 102 may associate different areas on display 122 and/or display 110 with different difficulties.

During a bonus round, a player may operate shooting device 150, inputs 134, and/or display 122 to “hit” an area on display 122 or display 110. Gaming machine 102 may then record the difficulty associated with the hit area to determine a player's overall score for the bonus round. In various embodiments, a hit may correspond to moving an on-screen object to a particular area (e.g., hitting a bowling pin with an on-screen bowling ball, driving a vehicle along a particular path, etc.). In other embodiments, a hit may correspond to aiming an input device (e.g., shooting device 150) at the on-screen area. For example, a player of gaming machine 102 may use input 134 in a golf-related bonus game to cause an on-screen golf ball to move on screen. Different areas of the screen may have different associated difficulties. For example, driving the ball in the game more than three hundred yards and at the center of the fairway may be more difficult than driving the ball into a sand trap. In other words, a hit in this case refers to the on-screen area at which the ball stops.

In another example, the player may aim shooting device 150 at an on-screen target on display 122 during a bonus round. When the trigger of shooting device 150 is pulled, a sensor located in shooting device 150 or on gaming machine 102 may detect the on screen location at which shooting device 150 is aimed. In response to receiving such data, gaming machine 102 may record the difficulty score associated with the screen location at which shooting device 150 is aimed. Gaming machine 102 may then use the difficulty scores from the player's shots from shooting device 150 to determine an overall score for the bonus round.

According to various embodiments, gaming machine 102 may use a player's overall score (e.g., a score determined from the tallied hit difficulties) to generate a bonus limit. Such a limit may be, or may represent, a maximum number of credits or monetary award that may be given to the player via the bonus round. In one embodiment, gaming machine 102 may randomly select the actual bonus award for the player from among values ranging from a minimum bonus amount to the bonus limit. The minimum bonus may be nonzero in some embodiments, (i.e., the player of gaming machine 102 is guaranteed to win at least the minimum bonus amount). For example, a player may have the opportunity to acquire an overall score of fifty in a bonus round, assuming that the player hits only the areas having the highest associated difficulties. If the minimum bonus amount is five credits, the player may win a bonus between five and fifty credits.

Gaming machine 102 may be configured to detect tampering with any of shooting device 150, inputs 134, and/or displays 110, 122. For example, shooting device 150 may be attached to gaming machine 102 via a cord 152 and stored in a housing 154 when not in use by a player. If a signal sent between shooting device 150 and gaming machine 102 via cord 152 is interrupted, gaming machine 102 may determine that a player has tampered with shooting device 150. In some embodiments, gaming machine 102 may disable bonus rounds within a game or disable the game itself, if tampering has been detected.

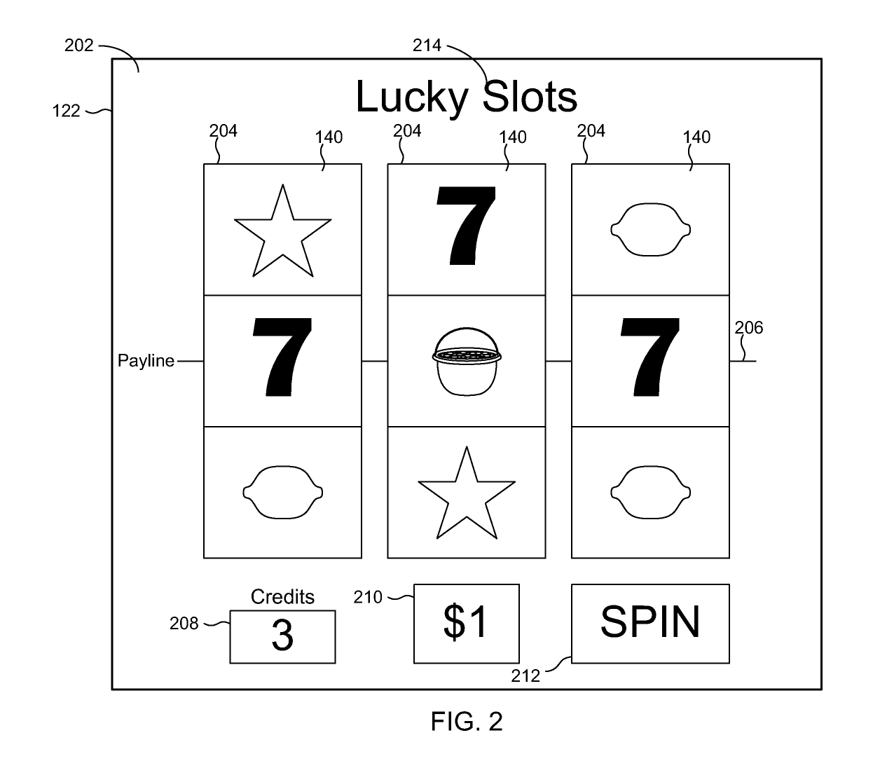

Referring now to FIG. 2, an illustration is shown of video display 122 from FIG. 1 in greater detail, according to one embodiment. As shown, gaming machine 102 may be in a state allowing a player to play a base game 202, such as a slot-based game. Various display data may be generated and provided to display 122, such as text 214 (e.g., the title of the game, “Lucky Slots”), text 210 (e.g., the cost per round of gameplay in base game 202), and an indication 208 of the number of credits available to the player. Display 122 may also display graphics, such as slot reels 140 in areas 204. Slot reels 140 may include any number of different symbols, such as stars, pots of gold, lemons, 7s, etc.

Base game 202 may be a wager-based game, allowing a player to place bets on the outcome of game 202. For example, display 122 may be a touch-screen display and may include a selectable area 212 that, when selected by a player, causes a round of gameplay to begin. In other embodiments, a round may be started via operation of a physical button, actuating a lever of gaming machine 102, or other similar action. Start of a round of gameplay may cause the number of credits indicated by indication 208 to be debited the cost indicated by text 210. For example, a player may wager a $1 credit per round of gameplay. In other embodiments, a player may optionally vary the wagered amount. For example, a player may place wagers across any number of paylines, in addition to payline 206 (e.g., other horizontal paylines, diagonal paylines, etc.).

During a round, reels 140 may appear on display 122 to spin, thereby showing different combinations of symbols. Depending on the combination of symbols shown along payline 206, the player may be deemed a winner and an amount credited to the player or dispensed by gaming machine 102 as physical money or tokens. For example, a jackpot amount may be paid in base game 202, if the symbols of reels 140 along payline 206 are each a seven. However, if a winning combination is not shown, the wagered amount will not be returned to be player's account. In some embodiments, the outcome of base game 202 may be determined using one or more random numbers. For example, gaming machine 102 may generate a random number for each of reels 140 that translate into corresponding reel positions (e.g., using a virtual table to map random numbers to reel positions).

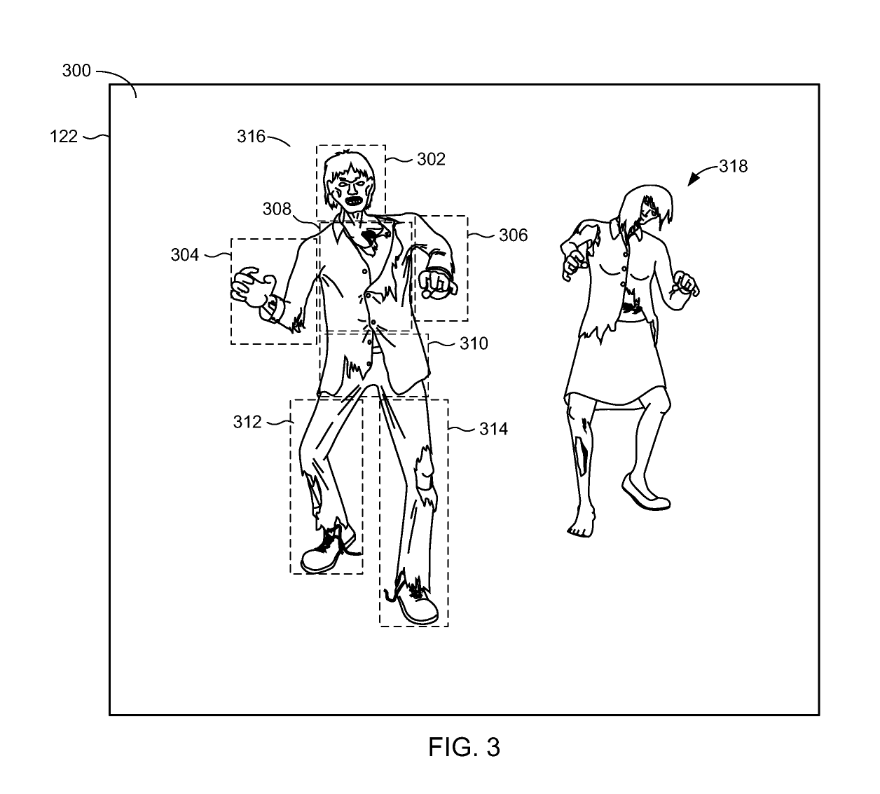

Referring now to FIG. 3, an illustration is shown of a bonus round 300 being displayed on display 122, according to one embodiment. Bonus round 300 may be provided to display 122 in conjunction with base game 202. In other words, bonus round 300 may be presented after certain conditions are met within base game 202. Exemplary conditions include, but are not limited to, a randomly generated number matching a predefined value, a certain in-game event occurring in base game 202 (e.g., one or more bonus round symbols aligning along payline 206, the player “unlocking” bonus round 300 via an in-game achievement, etc.), a time limit of gameplay being reached, the player participating in a round of group play in base game 202 (e.g., playing base game 202 with other players), the player of base game 202 wagering a certain amount, and the player of base game 202 achieving a loyalty-related achievement (e.g., earning a specific number of loyalty points by playing base game 202).

In the example shown, various targets 316, 318 may be displayed on-screen during bonus round 300. For example, targets 316, 318 may appear to the player of bonus round 300 as if the player were being attacked by zombies. In various embodiments, targets 316, 318 may appear at random times during bonus round 300, in different locations on display 122, and/or for a limited amount of time. In some embodiments, one or both of targets 316, 318 may be displayed only after the player reaches a certain in-game achievement in bonus round 300. For example, target 318 may be a “boss” target that appears randomly, after a certain amount of time of gameplay in bonus round 300, or after the player hits a certain number of on-screen targets. In one embodiment, a player may have a limited number of shots that may be taken in bonus round 300. For example, a player may be limited to fifty shots in bonus round 300. A player may also have a limited number of shots before being required to reload. For example, a player may have five shots before having to reload (e.g., by hitting a reload button, by shooting off-screen, etc.).

Each of targets 316, 318 may include one or more on-screen areas. For example, target 316 may be a humanoid target (e.g., a zombie) having on-screen areas 302-314. Each of areas 302-314 may correspond to a different body part of target 316. As shown, area 302 may correspond to the head of target 316, areas 304, 306 may correspond to the arms of target 316, area 308 may correspond to the upper torso of target 316, area 310 may correspond to the lower torso of target 316, and areas 312, 314 may correspond to the legs of target 316. Other exemplary forms of targets having body parts that may be assigned to different on-screen areas include, but are not limited to, animal targets, alien targets, and monster targets. In other embodiments, inanimate objects depicted on-screen may also have associated areas. For example, a fairway, a set of bowling pins, one or more bull's eyes, etc. may be subdivided into different on-screen areas.

In some embodiments, on-screen areas may be associated with different difficulty ratings. For example, area 302 may correspond to the head of target 316 and have a higher difficulty than area 308 which corresponds to the torso of target 316. In other words, it may be more difficult for a player using shooting device 150 to hit area 302 than area 308. Any number of different degrees of difficulty may be associated with the on-screen areas. For example, the following table may be used to map areas 302-314 to difficulty ratings:

TABLE 1

| Area | Difficulty | Average Payback |
|---|---|---|
| 302 | Hard | 1.6 |
| 304 | Hard | 1.6 |
| 306 | Hard | 1.6 |
| 308 | Easy | 0.6 |
| 310 | Easy | 0.6 |
| 312 | Hard | 1.6 |
| 314 | Hard | 1.6 |

Each difficulty rating in Table 1 may also have an average payback amount such that areas with hard difficulty ratings have a greater average payback than areas with easy difficulty ratings.

In some embodiments, difficulty ratings may be converted into payback amounts based on a random selection of weighted values. For example, easy shots may be weighted as follows:

TABLE 2

| Award | Weight |
|---|---|
| 0 | 3 |
| 1 | 1 |
| 2 | 1 |
| 3 | 0 |

Hard shots may also be weighted as follows:

TABLE 3

| Award | Weight |
|---|---|
| 0 | 0 |
| 1 | 3 |
| 2 | 1 |
| 3 | 1 |

Thus, the average payback for an easy shot will be ⅗=0.6 using the weightings in Table 2 and the average payback for a hard shot will be 8/5=1.6 using the weightings in Table 3. In some embodiments, each area of an on-screen target may be assigned potential payback amounts based on their respective difficulty ratings. For example, if one hundred targets appear in bonus round 300, the maximum possible award to a skilled player would be 100*3=300, based on the maximum possible award for a difficult shot per target in Table 3. However, the probability of such a maximum bonus award occurring would be (⅕)̂100. If the number of targets that appear in a bonus round is also randomly selected, the probability of an award of 300 may be even smaller. Using this approach, the average bonus awards for skilled and unskilled players may be predefined. Since each on-screen area is assigned a payback amount randomly selected based on its difficulty rating, the bonus round may be configured such that it remains possible for an unskilled player to achieve a higher award than a skilled player, in some embodiments. For example, a skilled player may receive a slightly higher bonus award than an unskilled player, but not so much or as frequently as to discourage the unskilled player from participating.

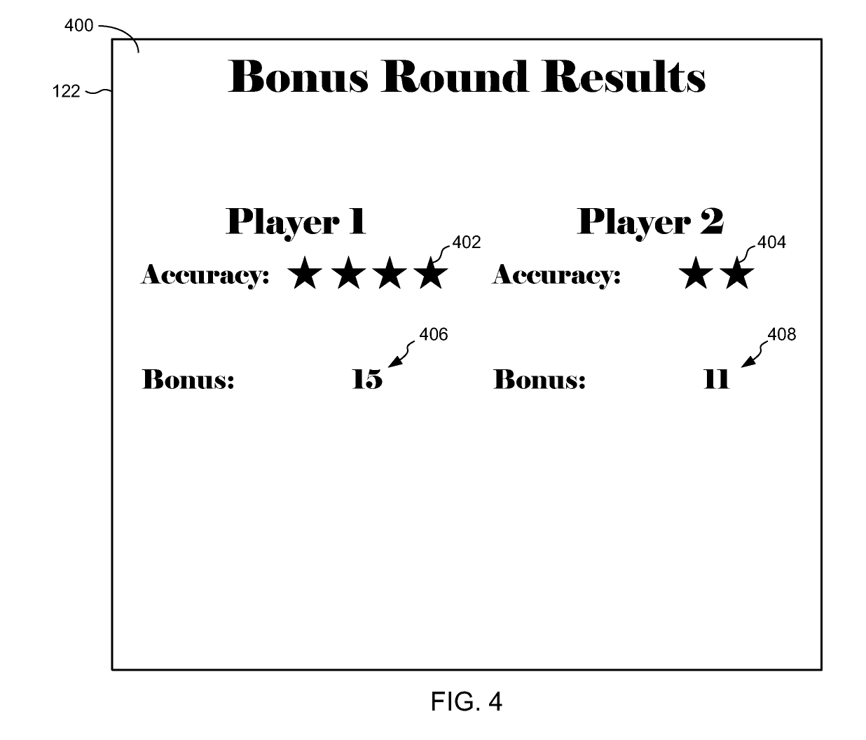

Referring now to FIG. 4, an illustration is shown of the results 400 of a bonus round being provided to a display of a gaming machine, according to an exemplary embodiment. In one example, results 400 may be displayed on display 122 at the conclusion of bonus round 300 shown in FIG. 3. Payback amounts per hit target may be tallied for each player of bonus round 300, to determine his or her bonus award. Results 400 may include indicia regarding each player's bonus award for bonus round 300. For example, results 400 may include indicia 406 indicating that a first player has won fifteen credits and indicia 408 indicating that a second player has won eleven credits by playing bonus round 300.

In various embodiments, the bonus awards for each player may be affected by his or her dexterity-based skill in bonus round 300. For example, results 400 may include accuracy ratings 402, 404 for the first and second player, respectively. Accuracy ratings 402, 404 may be based on, for example, the number of targets hit by each player, the difficulty associated with the areas hit by the player, and the number of shots taken by the player. As shown, the first player may have been more accurate in his or her shooting during bonus round 300 than the second player. For example, assume that the first player took a total of twelve shots and hit a total of ten targets, seven of which were hit in an area having a hard difficulty rating. Also, assume that the second player took a total of fifteen shots and hit a total of eight targets, four of which were hit in an area having a hard difficulty rating. In such a case, the first player may have a higher accuracy rating than the second player.

Typically, the player having a higher accuracy rating in a bonus round will receive a slightly higher bonus award than a player with a lower accuracy rating. However, it is also statistically possible that the opposite may occur. For example, assume that the second player hit areas having easy difficulty ratings, but were randomly assigned payback amounts that were higher than areas having hard difficulty ratings. In such a case, the second player may end up with a higher bonus award than the first player, even though the first player made a greater number of difficult shots. In some embodiments, a player may also receive a base bonus award, regardless of how well he or she fared in a bonus round. In further embodiments, bonus round 300 may be configured to allow a player to elect to have the game played automatically on behalf of the player.

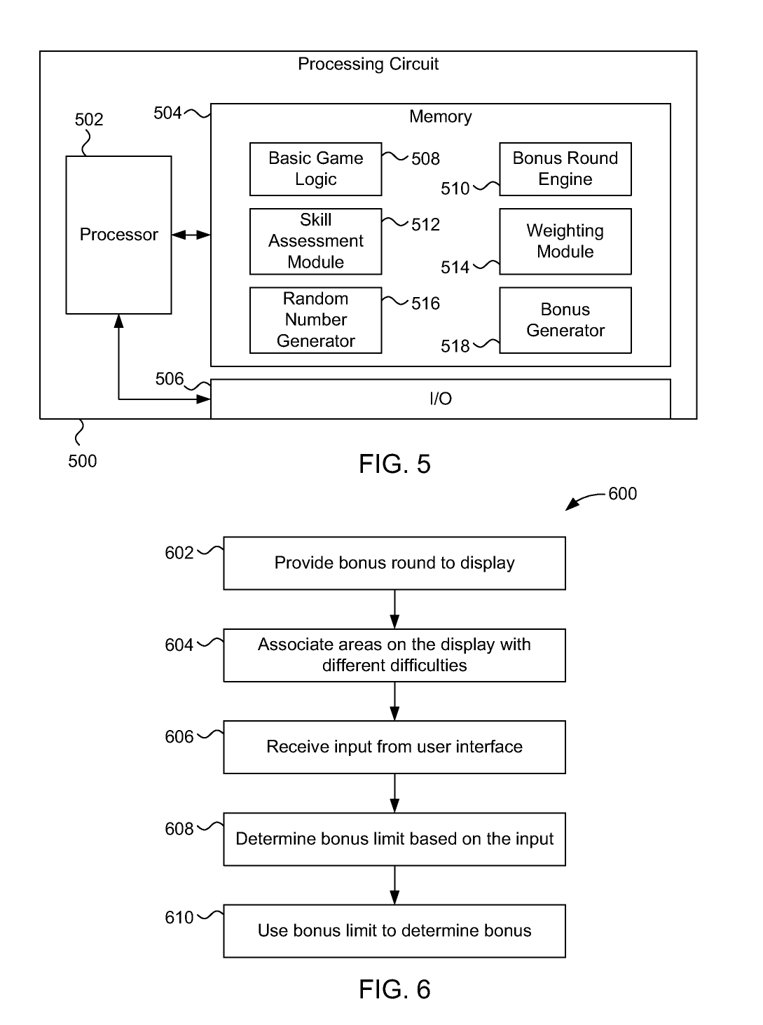

Referring now to FIG. 5, a block diagram of a processing circuit 500 configured to provide a bonus round is shown, according to an exemplary embodiment. Processing circuit 500 may be internal or external to a gaming machine, such as gaming machine 102 shown in FIG. 1. For example, processing circuit 500 may be located within main cabinet 104 of gaming machine 102 and in electronic communication with the various electronic components of gaming machine 102 (e.g., displays 110, 122, inputs 134, shooting device 150, etc.). In other embodiments, the processing circuit 500 may be located remotely and communicate with gaming machine 102 via a network. For example, processing circuit 500 may be part of a group controller for a bank of gaming machines. In another example, processing circuit 500 may be part of a remote server that provides a game to gaming machine 102 remotely (e.g., a thin client game).

Processing circuit 500 may include a processor 502 and a memory 504. Memory 504 stores machine instructions that, when executed by processor 502, cause processor 502 to perform one or more operations described herein. Processor 502 may include a microprocessor, FPGA, ASIC, any other form of processing electronics, or combinations thereof. Memory 504 may be any electronic storage medium such as, but not limited to, a floppy disk, a hard drive, a CD-ROM, a DVD-ROM, a magnetic disk, RAM, ROM, EEPROM, EPROM, flash memory, a solid state drive, optical memory, or combinations thereof. Memory 504 may be a tangible storage medium that stores non-transitory machine instructions. Processing circuit 500 may include any number of processors and memories. In other words, processor 502 may represent the collective processing devices of processing circuit 500 and memory 504 may represent the collective storage devices of processing circuit 500. Processor 502 and memory 504 may be on the same printed circuit board or may be in communication with each other via a bus or other form of connection.

Processing circuit 500 may include input and output (I/O) hardware 506 in communication with processor 502. I/O hardware 506 includes the interface hardware used by processing circuit 500 to receive data from other devices and/or to provide data to other devices. For example, processing circuit 500 may provide display data to display 122 and/or display 110 of gaming machine 102. I/O hardware 506 may include, but is not limited to, hardware to communicate on a local system bus and/or on a network. For example, I/O hardware 506 may include a port to transmit display data to an electronic display and another port to receive input data from a user interface device (e.g., shooting device 150, inputs 134, etc.). In another example, I/O hardware 506 may communicate remotely with one or more gaming machines via a network.

Memory 504 may include the executable instructions for one or more games. A game may generally include software modules configured to perform certain function when executed and to receive and provide data to the other modules of the game. As shown, a game stored in memory 504 may include base game logic 508, a bonus round engine 510, a skill assessment module 512, a weighting module 514, a random number generator 516, and a bonus generator 518. In some embodiments, some or all of software modules 510-518 may be shared with one or more other games. For example, two different games (e.g., a video slot game and a video poker game) may use bonus round engine 510 to include the same bonus round as part of the gameplay of the games. In another example, random number generator 516 may be used by any number of games to determine game outcomes. In further embodiments, some or all of the software modules may be implemented using a distributed architecture. For example, random number generator 516 may be stored in the memory of a server located remotely from processing circuit 500. In such a case, random numbers generated by random number generator 516 may be received by processing circuit 500 via a network also connected to the server.

Base game logic 508 is configured to conduct the base game playable in a gaming machine. Exemplary base games include, but are not limited to, video slot games, video card games (e.g., video poker, video blackjack, etc.), and other wager-based games. Base game logic 508 may provide display and/or audio data to any number of displays and speakers of a gaming machine. Base game logic 508 may also be configured to maintain a number of credits for a player. For example, base game logic 508 may receive an indication of inserted credits, tokens, or money into a gaming machine (e.g., base game logic 508 may receive data from bill acceptor 116, etc.). Base game logic 508 may also receive an indication of a wager placed by the player and debit the player's current number of credits, accordingly. In response to receiving a valid wager, base game logic 508 may use one or more random number generated by random number generator 516 to determine the outcome of the game. If base game logic 508 determines the player to be a winner, base game logic 508 may add to the player's credits, accordingly. However, if base game logic 508 determines the player to have lost, base game logic may debit the player's available credits, if it hasn't already done so.

Random number generator 516 is configured to generate one or more random numbers. Random number generator 516 may use any number of pseudorandom number generation techniques to generate a number. For example, random number generator 516 may employ the use of a number of linear feedback shift registers and numerical transformations to generate numbers. In some embodiments, random number generator 516 may utilize one or more hardware-generated numbers to determine the number.

Bonus round engine 510 may be configured to provide display and audio data for a bonus round to the displays and speakers of a gaming machine, in response to base game logic 508 determining that a bonus round is to be entered. Base game logic 508 may determine that a bonus round is to be provided based on whether any number of conditions exist. For example, base game logic 508 may provide an indication to bonus round engine 510 that a bonus round is to be entered based on a player wagering a certain amount in the base game, the player playing the base game for a certain amount of time, an outcome of a round of the base game (e.g., bonus round symbols appearing on a slot game's payline, etc.), randomly, or periodically. In some embodiments, bonus round engine 510 may provide any number of different bonus round. For example, bonus round engine 510 may utilize different levels of bonus rounds, the levels being accessible by a player in sequential order (e.g., a player that completes the first level may be eligible later for the second level, etc.). In other embodiments, bonus round engine 510 may use a random number from random number generator 516 to randomly select which bonus round is to be provided.

According to various embodiments, display data generated by bonus round engine 510 may cause one or more on-screen areas to appear. For example, bonus round engine 510 may cause a target to appear on a display that has one or more associated areas. Targets and on-screen areas hittable during gameplay may be generated randomly by bonus round engine 510, may be displayed in a predetermined order and at predetermined locations, or may be displayed after a certain number of hits have been registered. For example, bonus round engine 510 may cause a “boss” character to appear on screen after a player hits a certain number of targets or after a certain amount of gameplay has elapsed.

Bonus round engine 510 may receive game input from one or more user interface devices of a gaming machine and use the input to determine whether one of the on-screen areas has been hit. For example, a player may point a shooting device at an on-screen area and actuate the device's trigger. In response, processing circuit 500 may receive input from a sensor regarding the area and determine whether the hit area corresponds to a target. In another example, a player may utilize a user interface device (e.g., a trackball, a touch-screen display, etc.) to move an on-screen object to another on-screen area. The final location of the on-screen area may register as the hit area.

Bonus round engine 510 may limit the number of attempts made by a player, in some embodiments. For example, a player may have a limited number of turns or shots in a bonus round. In another example, a player may have a limited number of shots before being required to reload. Reloading may correspond to another action by a player, such as shooting an off-screen area, shooting a particular on-screen target, hitting a reload button, etc.

Skill assessment module 512 may associate difficulty ratings to on-screen areas generated by bonus round engine 510. For example, an on-screen target generated by bonus round engine 510 may include different areas having varying difficulty ratings from skill assessment module 512. Difficulty ratings may be based, for example, on the number of pixels of the on-screen area or any other factor that affects a player's ability to hit the area. Skill assessment module 512 may also generate various statistics for a player and provide the statistics to a display. For example, skill assessment module 512 may generate statistics regarding the number of shots or tries made by a player, the number of targets hit by the player, the average difficulty of the hit targets, and other such statistics.

In some embodiments, weighting module 514 may associate different weightings to a difficulty rating. For example, bonus round engine 510 may determine that a particular on-screen area has been hit by a player. In response, weighting module 514 may use the difficulty rating associated with the hit area to determine a payback amount. In some embodiments, weighting module 516 may use a bonus limit and one or more weighting values to control the average payback amount for a given difficulty rating. For example, an area having a hard difficulty rating may have a higher average payback amount than an area having an easy difficulty rating. In some embodiments, weighting for a given difficulty rating may corresponds to probabilities that a given payback amount will be selected by weighting module 514. For example, a payback amount for a given on-screen area having a hard difficulty may range from a value of 0-4, but have a probability of ⅛ of a payback amount of four being selected by weighting module 514. Thus, an area having a hard difficulty rating may have a higher average payout amount than an area having an easy difficulty rating, but does not necessarily guarantee that a higher payout amount will result.

Bonus generator 518 may tally the payback amounts from weighting module 514 to determine an overall bonus award for a player of a bonus round. Bonus generator 518 may then credit a player's account with the bonus award and/or pay out a monetary amount equal to the bonus award. In some embodiments, bonus generator 518 may generate a minimum bonus award for a player, regardless of the player's dexterity-based actions in the bonus round. For example, a player that takes no shots during a bonus round may still receive a base bonus. In one embodiment, a base bonus may be selected by bonus generator 518 in a manner similar to the selection of a payout amount by weighting module 514 for a hit target. For example, an average base bonus amount may be ten credits, but may be selected randomly from values ranging from five to fifteen credits.

Referring now to FIG. 6, a flow diagram is shown of a process 600 for providing a bonus round, according to an exemplary embodiment. Process 600 may be implemented by one or more processing circuits that execute machine instructions. For example, process 600 may be implemented by a processing circuit in gaming machine 102 of FIG. 1, a server in communication with gaming machine 102, a controller for a bank of gaming machines, or a distributed set of computing devices. In general, process 600 allows a bonus round to be run within a base game. The base game is configured such that a player may utilize one or more user interface devices to influence the amount of a bonus award from the bonus round, i.e., based on the player's dexterity-based skill with the user interface device. The bonus round may also be configured such that a skilled player has a slightly higher probability of winning a larger bonus award than an unskilled player, although this may not always be the case.

Process 600 includes providing a bonus round to one or more displays of a gaming machine (block 602). The bonus round may be entered from the base game in response to any number of different events. For example, a player may enter a bonus round based on the amount the player has wagered, based on an outcome of a round in the base game, based on other players joining the game (e.g., as part of a group play across multiple gaming machines), based on a player's loyalty account, based on the amount of time the player has been playing the base game, or randomly. According to some embodiments, the combined payouts for the base game and any bonus round may be above a specified threshold. For example, awards from a game and its bonus rounds may pay out an average of 80% of the credits entered into the gaming machine.

Process 600 also includes associating one or more areas of the display with different difficulty ratings (block 604). In some embodiments, a bonus round may include one or more on-screen targets. A target generally refers to an on-screen area or a set of on-screen areas with which a player may interact using a user interface device. For example, a target may be an on-screen zombie at which a player may shoot using a peripheral shooting device. Each target may have one or more hittable areas and the hittable areas may have differing associated difficulties. In one embodiment, targets may be spawned on screen randomly during a bonus round. In another embodiment, targets may appear on screen based on a time of gameplay and/or in predefined locations. For example, a zombie target may jump out of an on-screen box at exactly 1 m:30 s into gameplay of the bonus round. Thus, a player that frequently plays the bonus round may come to expect where certain targets are going to appear. In further embodiments, some targets may appear on-screen based on previously hit targets. For example, a boss zombie may be displayed after a player hits a certain number of zombies during the bonus round.

Difficulty ratings may be associated with the on-screen areas based on any number of factors. For example, an on-screen area may receive a difficulty rating based on its size, the amount of movement of the on-screen target (e.g., a moving target may be more difficult to hit than a stationary target, a fast moving target may be harder to hit than a slow moving target, etc.), the rarity of the target, the amount of time the target remains on screen, and other factors that may affect the amount of dexterity needed by a player to hit the on-screen area. In one embodiment, a history of on-screen hits may be used to generate difficulty ratings for the corresponding areas. For example, assume that only 10% of players hit a particular on-screen area of a target during a bonus round in the past month. In such a case, the area may receive a high difficulty rating based on the historical performance of other players.

Process 600 includes receiving game input from a user interface (block 606). In general, a user interface may be any form of electronic device configured to receive sensory data from a player. Exemplary user interfaces include, but are not limited to, touch screen displays, shooting devices, pointing devices, buttons, track pads, track balls, keypads, pressure sensors, and motion sensors. In response to receiving the game input, a corresponding on-screen or off-screen location may be determined. For example, assume that a player activates a shooting device peripheral of a gaming machine. In response, game data may be received and analyzed to determine the location at which the player was aiming when the shooting device was activated. The location may correspond to an on-screen area or may correspond to an off-screen area, depending on where the player was aiming at the time.

Process 600 also includes determining a bonus limit based in part on the received game input (block 608). Generally, a bonus limit defines an upper payback amount awardable to a player that hits a particular on-screen area. For example, an area having an easy difficulty rating may have a bonus limit of five credits, while an area having a hard difficulty rating may have a bonus limit of ten credits. An area with a particular difficulty rating may also have a minimum payback amount. The minimum payback amount may be zero or non-zero, in various embodiments. For example, an on-screen area may have a corresponding payback amount ranging from zero to four credits or ranging from one to five credits. In one embodiments, a minimum payback amount may be a negative value. For example, a bonus round that includes zombie targets on screen may also display an elderly woman. Since the goal of the bonus round is to hit zombies and not humans, on-screen areas for the elderly woman may have a negative minimum payback amount up to a bonus limit of zero.

Process 600 includes using a bonus limit to determine a bonus award for a player (block 610). In some embodiments, a payback amount may be selected randomly from among payback amounts ranging from a minimum payback amount and the bonus limit. For example, assume that an on-screen target is a bull's eye that has three on-screen areas: a bull's eye, a middle ring, and an outer ring. The area for the bull's eye may have the highest difficulty rating and a possible payback amount ranging from one to five credits. Conversely, the area for the outer ring may have the easiest difficulty and a possible payback amount ranging from zero to four credits. In some embodiments, the different payback amounts for a difficulty rating may be weighted such that different difficulty ratings have different average payback amounts. For example, the probabilities for a payback range of one to four may be 4/8, 2/8, ⅛, and ⅛, respectively. In such a case, the average payback amount for hitting the on-screen area will be 1.875 (e.g., (4*1+2*2+1*3+1*4)/8=1.875). However, since the payback amount is selected randomly, an actual player may receive a payback amount ranging anywhere from one to four. Payback amounts for the hit target may then be tallied to determine the bonus amount the player receives for playing the bonus round. In some cases, the tallied payback amounts may be converted on a one-to-one basis into a bonus award. In other cases, the tallied payback amounts may be converted into a bonus award of credits, tokens, or physical money using a conversion mapping. For example, a player earning a total payback amount of twenty may receive a bonus award of ten dollars.

In some embodiments, a player may receive a bonus award, regardless of how well he or she fared in the bonus round. For example, a player having little or no skill may obtain zero or negative payback amount, based on his or her skill in the bonus round. Nonetheless, the player may still receive a bonus award. In one embodiment, a player may receive a fixed amount as a bonus award, regardless of his or her skill in a bonus round. In another embodiment, a player may receive a variable amount as a bonus award. For example, a bonus award may be selected for the player from bonus awards ranging from a minimum base award to a maximum base award. The range of awards may also be weighted such that certain awards are more likely than others. For example, a player may be eligible for a bonus award ranging from one credit to ten, but the average base award is set to be three credits.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular embodiments. Certain features that are described in this specification in the context of separate implementations or embodiments can also be implemented in combination in a single implementation. Conversely, various features that are described in the context of a single implementation or embodiment can also be implemented in multiple implementations or embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method of providing a bonus round in a gaming machine comprising:
providing, by a processing circuit, display data for the bonus round to an electronic display;
associating, by the processing circuit, areas of the displayed bonus round with difficulty ratings;
receiving, at the processing circuit, game input from a user interface device, the game input corresponding to one of the displayed areas of the bonus round;
determining, by the processing circuit, a bonus limit based in part on the game input from the user interface device, the bonus limit being determined using the difficulty rating for the displayed area corresponding to the game input; and
using, by the processing circuit, the bonus limit to determine a bonus award for the bonus round.

2. The method of claim 1, wherein the bonus award is determined by randomly picking a value between a minimum bonus and the bonus limit.

3. The method of claim 2, wherein the minimum bonus is a positive amount.

4. The method of claim 2, further comprising:
randomly selecting an area to be displayed in the bonus round, wherein the display data for the bonus round comprises the randomly selected area, and wherein the randomly selected area has an associated difficulty rating.

5. The method of claim 1, wherein the user interface device comprises at least one of a shooting device, a touch-screen display, a joystick, or a trackball device.

6. The method of claim 1, wherein the displayed areas correspond to displayed body parts.

7. The method of claim 1, further comprising:
randomly selecting, by the processing circuit, a turn limit value; and
using the turn limit value to limit the number of game inputs from the user interface device during the bonus round.

8. A system for providing a bonus round in a gaming machine comprising a processing circuit configured to:
provide display data for the bonus round to an electronic display;
associate areas of the displayed bonus round with difficulty ratings;
receive game input from a user interface device, the game input corresponding to one of the displayed areas of the bonus round;
determine a bonus limit based in part on the game input from the user interface device, the bonus limit being determined using the difficulty rating for the displayed area corresponding to the game input; and
use the bonus limit to determine a bonus award for the bonus round.

9. The system of claim 8, wherein the bonus award is determined by randomly picking a value between a minimum bonus and the bonus limit.

10. The system of claim 9, wherein the minimum bonus is a positive amount.

11. The system of claim 9, wherein the processing circuit is further configured to randomly select an area to be displayed in the bonus round, wherein the display data for the bonus round comprises the randomly selected area, and wherein the randomly selected area has an associated difficulty rating.

12. The system of claim 8, wherein the user interface device comprises at least one of a shooting device, a touch-screen display, a joystick, or a trackball device.

13. The system of claim 8, wherein the displayed areas correspond to displayed body parts.

14. The system of claim 8, wherein the processing circuit is further configured to randomly select a turn limit value and to limit the number of game inputs from the user interface device during the bonus round using the turn limit value.

15. A computer-readable storage medium having instructions stored therein, the instructions being executable by a processor to cause the processor to perform operations comprising:
providing display data for the bonus round to an electronic display;
associating areas of the displayed bonus round with difficulty ratings;
receiving game input from a user interface device, the game input corresponding to one of the displayed areas of the bonus round;
determining a bonus limit based in part on the game input from the user interface device, the bonus limit being determined using the difficulty rating for the displayed area corresponding to the game input; and
using the bonus limit to determine a bonus award for the bonus round.

16. The computer-readable storage medium of claim 15, wherein the bonus award is determined by randomly picking a value between a minimum bonus and the bonus limit.

17. The computer-readable storage medium of claim 16, wherein the minimum bonus is a positive amount.

18. The computer-readable storage medium of claim 16, wherein the operations further comprise:
randomly selecting an area to be displayed in the bonus round, wherein the display data for the bonus round comprises the randomly selected area, and wherein the randomly selected area has an associated difficulty rating.

19. The computer-readable storage medium of claim 15, wherein the displayed areas correspond to displayed body parts.

20. The computer-readable storage medium of claim 15, wherein the operations further comprise:
randomly selecting a turn limit value; and
limiting the number of game inputs from the user interface device during the bonus round using the turn limit value.
